(19) United States
(12) Patent Application Publication
(10) Pub. No.: US 2026/0227852 A1
(43) Pub. Date: Aug. 6, 2026

(54) IMAGE PROCESSING DEVICE AND IMAGE PROCESSING METHOD

(71) Applicant: CANON KABUSHIKI KAISHA, Tokyo (JP)

(72) Inventor: JUN YAMAMOTO, Tokyo (JP)

(21) Appl. No.: 19/445,365

(22) Filed: Jan. 9, 2026

(30) Foreign Application Priority Data
Feb. 4, 2025 (JP) 2025-016814

(51) Int. Cl. G06F 3/01; G06F 3/0346; G06T 19/20

(52) U.S. Cl. CPC G06F 3/013; G06F 3/012; G06F 3/017; G06F 3/0346; G06T 19/20; G06T 2219/2004

(57) ABSTRACT

An image processing device includes one or more memories, and one or more processors in communication with the one or more memories, wherein the one or more processors and the one or more memories are configured to: recognize a virtual display object selected in a virtual space; set working posture information corresponding to a working posture of a user when the user works while referring to the virtual display object; and set a display position of the virtual display object based on the set working posture information.

### BACKGROUND

### Field of the Technology

The present disclosure relates to an image processing device and an image processing method.

### Description of the Related Art

A head-mounted display apparatus that handles an object placed in a virtual space, such as mixed reality (MR), augmented reality (AR), or virtual reality (VR) are becoming increasingly widespread. Some of such virtual objects have functions and roles as a display that displays information, and users can perform work while referring to a display that serves as a virtual display object.

In a virtual space, in a case where the position of a virtual display object is far from the user, the user can move the virtual display object by an object operation to a position where the user can easily refer to the virtual display object, such as a position in front of his/her eyes. Known object operations include a pulling action using a hand gesture, movement to arbitrary coordinates by inputting a command button, and the like. For example, Japanese Patent Laid-Open No. 2019-139672 describes that, in a head-mounted display device, when the user performs a predetermined operation on a selected virtual display object, the information regarding the virtual display object is displayed in front of the user's eyes.

In a case where the user performs work while referring to a virtual display object, there are the following issues regarding the position to which the virtual display object is pulled and the method for pulling the virtual display object closer.

The position to which the virtual display object is pulled is based on the posture (selection posture) of the user at the time of selecting the virtual display object. On the other hand, the position where the user desires to actually place the virtual display object is based on the working posture of the user who is to refer to the virtual display object. For example, readjusting these positional relationships may cause inconvenience and inefficiency for a user who does not want to disrupt the working posture. In the prior art representatively described in Japanese Patent Laid-Open No. 2019-139672, such issues are not taken into consideration.

### SUMMARY

The present disclosure is directed to providing a user-friendly image processing device that can arrange a virtual display object at a position appropriate for a user by considering a working posture of the user who performs work while referring to the virtual display object in the selection and movement of the virtual display object.

According to an aspect of the present invention, an image processing device includes one or more memories, and one or more processors in communication with the one or more memories, wherein the one or more processors and the one or more memories are configured to: recognize a virtual display object selected in a virtual space; set working posture information corresponding to a working posture of a user when the user works while referring to the virtual display object; and set a display position of the virtual display object based on the set working posture information.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic diagrams illustrating the external appearance of a head-mounted display apparatus according to a first embodiment.

FIG. 2 is a block diagram illustrating an electrical configuration of the head-mounted display apparatus according to the first embodiment.

FIG. 3 is a schematic diagram illustrating the principle of an eye gaze detection method.

FIGS. 4A and 4B are schematic diagrams illustrating luminance at each position of an eyeball.

FIG. 5 is a flowchart illustrating an eye gaze detection operation according to the first embodiment.

FIG. 6 is a flowchart illustrating the overview of a virtual display object position control method, which is based on a working posture of a user, according to the first embodiment.

FIG. 7 is a flowchart illustrating a specific example of the setting of working posture information.

FIG. 8 is a flowchart illustrating a specific example of the selection of a virtual display object.

FIG. 9 is a flowchart illustrating a specific example of the position setting of a virtual display object, which is based on working posture information.

FIG. 10 is a flowchart illustrating a specific example of the display control of a virtual display object.

FIGS. 11A to 11C are schematic diagrams visually illustrating the display of a virtual display object according to the first embodiment.

FIG. 12 is a block diagram illustrating an electrical configuration of a head-mounted display apparatus according to a third embodiment.

FIG. 13 is a flowchart illustrating the overview of a virtual display object position control method, which is based on a working posture of a user, according to the third embodiment.

FIG. 14 is a flowchart illustrating a specific example of acquisition of a relevance degree of selected virtual display objects.

FIGS. 15A to 15C are schematic diagrams visually illustrating the display of a plurality of virtual display objects with a high relevance degree according to the third embodiment.

### DESCRIPTION OF THE EMBODIMENTS

### —Basic Configuration of Image Processing Device According to Various Embodiments—

To specifically describe various embodiments, a basic configuration of an image processing device according to the various embodiments will be described.

An image processing device according to an embodiment of the present disclosure includes a virtual display object selection unit, a working posture setting unit, and a virtual display object control unit. The virtual display object selection unit recognizes a virtual display object selected in a virtual space. The working posture setting unit sets working posture information corresponding to the working posture of a user, which is to be assumed when the user performs work while referring to a virtual display object. The virtual display object control unit sets a display position of the virtual display object based on the working posture information set by the working posture setting unit.

After the user selects a virtual display object at a predetermined posture (selection posture: e.g., standing state), the user assumes a posture (working posture: e.g., seated state) for performing work while referring to the virtual display object and carries out the work. Since the working posture often differs from the selection posture, in the image processing device according to an embodiment of the present disclosure, the virtual display object control unit sets the display position of the virtual display object based on the working posture information corresponding to a working posture set by the working posture setting unit. For this reason, the selected virtual display object is controlled to be automatically arranged at a display position corresponding to the working posture, based on the working posture information set by the working posture setting unit, without the user going through movement of the virtual display object to a display position corresponding to the selection posture. In this manner, according to an embodiment of the present disclosure, an image processing device with excellent convenience is realized, enabling placement of a virtual display object at a position appropriate for the user.

### SPECIFIC DESCRIPTION OF VARIOUS EMBODIMENTS

Hereinafter, various embodiments of the present disclosure will be described in detail with reference to the drawings. It should be noted that the following embodiments do not limit the invention according to the claims. Although a plurality of features is described in the embodiments, not all of these features are necessarily essential, and the plurality of features may be combined arbitrarily. Furthermore, in the drawings, identical or similar components are denoted by the same reference numerals, and redundant descriptions are omitted.

### First Embodiment

Hereinafter, the first embodiment of the present disclosure will be described.

In the present embodiment, a head-mounted display apparatus, such as a glasses-type, that arranges a virtual display object at a position appropriate for a user by considering a working posture of the user who is to refer to the virtual display object in the selection and movement of the virtual display object will be described as an image processing device.

### <Description of Head-Mounted Display Apparatus>

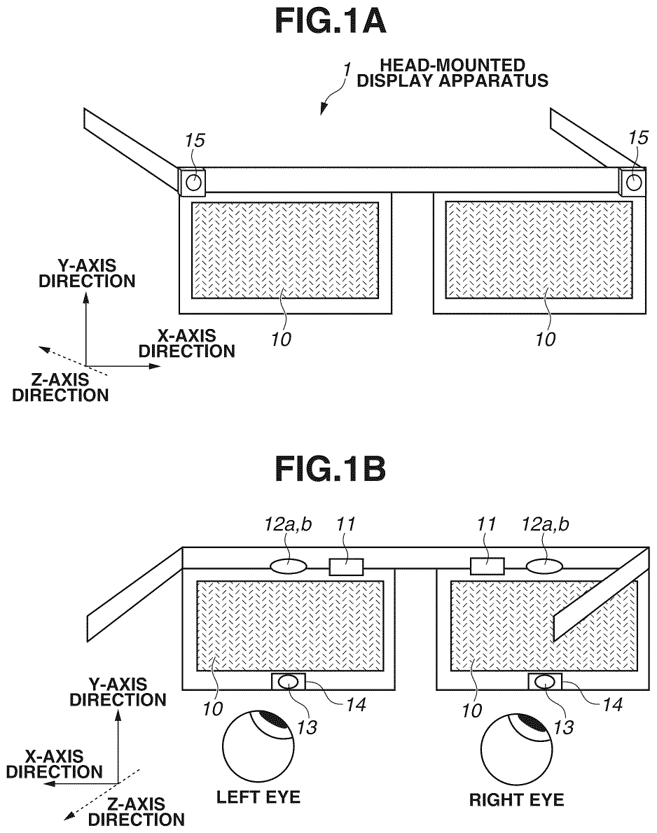

FIGS. 1A and 1B are schematic diagrams illustrating the external appearance of a head-mounted display apparatus 1 according to the present embodiment. FIG. 1A is a front perspective view and FIG. 1B is a back perspective view.

Here, the head-mounted display apparatus 1 will be described as head-mounted display apparatus of an optical see-through type for mixed reality (MR).

The head-mounted display apparatus 1 according to the present embodiment can be applied to an optical see-through method, a video see-through method, an artificial virtual space like a game world, and the like, aside from the types of augmented reality (AR), mixed reality (MR), and virtual reality (VR).

The head-mounted display apparatus 1 includes lens elements 10, and the user of the head-mounted display apparatus 1 views external scenery through the lens elements 10.

The head-mounted display apparatus 1 also includes virtual object display elements 11, and the virtual object display elements 11 superimpose and display a virtual image (CG), which is digital information, onto the field of view of the left and right eyes of the user through an optical system while allowing the user to see the external worlds. The category of virtual objects includes virtual display objects that display information, such as displays and windows. It also includes graphical user interfaces (GUIs) such as buttons and icons.

In the optical see-through method, the user views the real space through the lens elements 10 each serving as a display surface, and has a mechanism for superimposing digital information thereon using an optical system such as a prism or a half mirror. Similarly, a method that uses non-light-shielding transmissive displays as the lens elements, allowing the user to view the real space through the displays and superimposes digital information thereon is also included in the optical see-through method.

The video see-through method that uses light-shielding lens elements as the lens elements 10, and directly displays a live view captured by external world imaging units 15 to be described below or a recorded moving image on the lens elements 10, or displays the live view or the recorded moving image after processing it can also be used. Furthermore, a method of displaying a virtual space like VR can also be used.

The head-mounted display apparatus 1 also includes illumination light sources 12 such as light-emitting diodes that emit infrared light imperceptible to the user, and each of the illumination light sources 12 illuminates the eyeball of the user. Part of illumination light reflected on the eyeball is condensed to an eyeball image sensor 14 via a light receiving lens 13. By using these configurations, it is possible to acquire eye-gaze information (gaze point and convergence angle information) of the user as described below.

The external world imaging units 15 capture a scene of the external world in a direction in which the user's face is oriented. The external world imaging unit 15 includes an image sensor, and is provided with several functions for acquiring external information. For example, each external world imaging unit 15 has a function of detecting and recognizing the hand and arm of the user, and tracking their movement. The function is generally referred to as hand tracking, and analyzes a specific hand motion (gesture) of the user. For example, by associating an operation of tapping a GUI button with a finger with an operation of pressing a button, it becomes possible to perform a hand gesture operation for the GUI.

In addition, each external world imaging unit 15 has a function of acquiring distance information of a real object existing in the external world. By detecting depth information or the like of the hand of the user, it becomes possible to more accurately recognize a relationship between the position of the hand of the user and the position of a virtual object placed in the virtual space. A known technique may be used as a distance detection method. For example, the distance detection method may be a method of emitting acoustic waves, radio waves, light waves (laser light, light-emitting diode (LED) light), or the like to a target object, and measuring a time until the waves are reflected to return. The light detection and ranging (LiDAR) that uses laser light, the time of flight (TOF) that uses LED light, and the like are widely known as a distance measuring sensor. In addition, the distance detection method may be a method of calculating a distance from an image obtained by a camera or an image sensor. For example, a stereo camera that measures a distance using two cameras, a phase difference autofocus (AF) technique that measures a distance using different pixels on an image sensor surface, and the like have been known. In the present embodiment, the phase difference AF technique is applied.

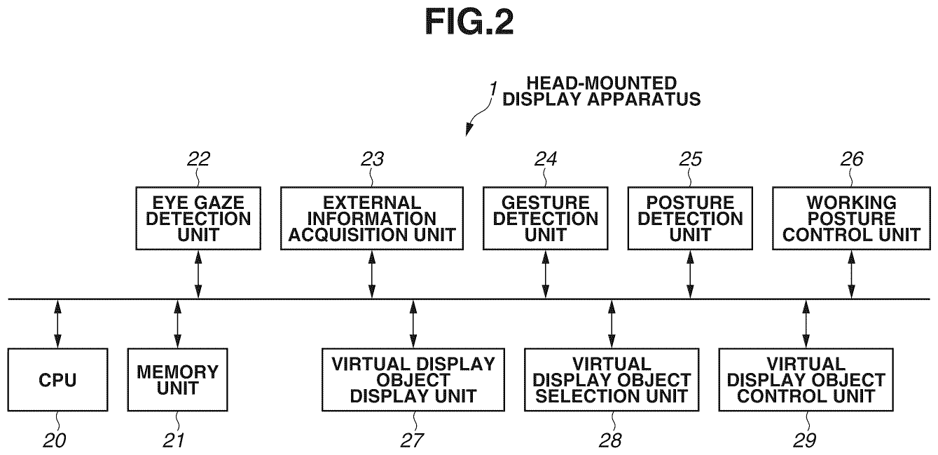

FIG. 2 is a block diagram illustrating an electrical configuration of the head-mounted display apparatus 1 according to the present embodiment.

A central processing unit (hereinafter, CPU) 20 of a microcomputer embedded in the head-mounted display apparatus 1 controls electrical circuitry of each of connected components 22 to 29. In the various embodiments, a case where the components 22 to 29 (22 to 30 in a third embodiment) are provided separately from the CPU 20 will be described. Nevertheless, instead of providing the components separately from the CPU 20, the CPU 20 may implement part or all of the functions of the components. In addition, a memory unit 21 associated with the CPU 20 has a storage function for various data transmitted from each component. The data stored in the memory unit 21 can be transmitted to each component via the CPU 20.

An eye gaze detection unit 22 has a function of detecting the eye gaze of the user. For example, the eye gaze detection unit 22 is digital serial interface circuitry, and transmits, to the CPU 20, an output obtained by forming an eyeball image from the eyeball image sensor 14. The CPU 20 extracts each feature point of an eyeball image necessary for eye gaze detection, in accordance with a predetermined algorithm to be described below, and further calculates the eye gaze (gaze direction) of the user from the position of each feature point. From an eye gaze detection result (will also be referred to as eye-gaze information or gaze point information), it is possible to identify a virtual object at which the user gazes.

An external information acquisition unit 23 has a function of acquiring external information in the real space. The external information includes information regarding a real object existing near the user. The external information acquisition unit 23 performs analog-to-digital (A/D) conversion of signal voltages from a plurality of pixels in a charge-coupled device (CCD) image sensor or a complementary metal-oxide-semiconductor (CMOS) image sensor included in the external world imaging unit 15, for example, and transmits the converted signal voltages to the CPU 20. The CPU 20 can acquire external information from the signals of a plurality of pixels. In addition, the external information acquisition unit 23 calculates a distance to a subject corresponding to each distance detection point, based on phase difference detection of the plurality of pixels. The position of the hand of the user and the position of an object existing near the user can also be calculated.

A gesture detection unit 24 recognizes gesture information of the user from image capturing information of the external world imaging unit 15, tracks its motion, and transmits the gesture information to the CPU 20. The CPU 20 determines whether the gesture of the user is a specific motion, and in a case where the gesture is the specific motion, executes an operation associated with the gesture.

A posture detection unit 25 has a function of detecting a posture of the user, and as an example, includes at least one of a gyro sensor and an acceleration sensor, and the like. A signal detected by the posture detection unit 25 is transmitted to the CPU 20, and the CPU 20 analyzes the detected signal and calculates an inclination amount of the head of the user that has been obtained at the time of signal detection. In addition, a translational movement amount (horizontal/vertical direction) of the head can also be calculated from the acceleration sensor. A change in the position or the orientation (direction) of the face of the user in the real spatial coordinate system (world coordinate system) can be calculated from the inclination amount or the movement amount, and the position of a virtual object placed in the same spatial coordinate system can be synchronized with the viewpoint position of the user.

Furthermore, by combining the image capturing information obtained by the external world imaging unit 15 (for example, image capturing information regarding the user's body such as the arm or the hand of the user, the amount of change in an external subject), it is possible to acquire information regarding the orientation of the user's body or the like relative to the current orientation of the face of the user. In addition, by setting the position of the face or the body of the user as a reference spatial coordinate when the head-mounted display apparatus 1 is activated or at another timing, it is possible to acquire the current spatial coordinate of the face or the body of the user from the measurement of the amount of change in the horizontal and vertical directions from the reference spatial coordinate.

A working posture control unit 26 has a function of setting and updating working posture information regarding the user.

The working posture refers to the posture of the user when the user performs work while referring to a virtual display object.

Information corresponding to the working posture is referred to as working posture information. At least one of spatial coordinate information, orientation (direction) information, and gesture information of the face or the body (including the arm and the hand) of the user, and the eye gaze of the user at the working posture serves as working posture information to be set by the working posture control unit 26. The working posture information regarding the user may be pre-registered before actual work, or may be registered in an actual working state in which the user is performing work while referring to a virtual display object. Aside from these timings, the working posture information regarding the user may be registered or changed at an arbitrary timing. A working posture may be fixed, or may change each time.

A virtual display object display unit 27 has a function of displaying a virtual display object superimposed on the lens elements 10. The virtual display object display unit 27 controls a virtual display object to be displayed at an arbitrary coordinate position, based on the real spatial coordinate system (world coordinate system) set in the virtual space. The virtual display object continues to float and stay at the same spatial coordinate; however, the spatial coordinate position of the virtual display object can be appropriately changed by a pull-in operation of the user or by the control executed by a virtual display object control unit 29. In addition, the size of the virtual display object can also be appropriately enlarged or reduced.

A virtual display object selection unit 28 has a function of recognizing a virtual display object selected by the user, detects whether a virtual display object has been selected by the user, and maintains the detected virtual display object in a selected state. In the detection of the selection, eye-gaze information of the user with respect to the virtual display object may be used, or gesture information regarding the user such as pointing at the virtual display object or directing a controller toward the virtual display object may be used. Furthermore, for clarification of the selection, an input operation for confirmation, such as using a GUI, a controller button, a gesture, or the like, may be separately performed. In the present embodiment, a case where eye-gaze information of the user is used will be described. The virtual display object selection unit 28 recognizes the selection of a virtual display object that has been made by the user, based on a time-series gaze state of the eye gaze at the virtual display object (for example, time during which the user gazes at the virtual display object).

The virtual display object control unit 29 has a function of controlling the display in the virtual space of the virtual display object recognized by the virtual display object selection unit 28. Specifically, the virtual display object control unit 29 moves and changes the display position of the selected virtual display object to a display position that is based on working posture information corresponding to a working posture of the user. The characteristic lies in that the display position is moved to the display position that is based on the working posture information, without passing through, for example, a display position that corresponds to selection in the virtual space (a spatial coordinate position of a virtual display object displayed based on the selection posture of the user). Changing the spatial coordinate position to the display position that is based on the working posture information needs not go through a pulling operation or the like of the virtual display object that is performed by the user from the display position at the selection timing, and performed by automatic processing. If the working posture of the user is fixed, the display position of the virtual display object facing the working posture may be set to an absolute spatial coordinate position specified for the assigned position of the working posture in advance. In addition, if the working posture of the user varies, a relative spatial coordinate position that is based on the working posture may be set as a display position.

The virtual display object control unit 29 may separately have a function of first displaying a selected virtual display object in front of the eyes of the user. In this case, the display of the virtual display object is based on the selection posture when the user selects the virtual display object. The virtual display object control unit 29 may further have a function of switching the display of a virtual display object that is based on the working posture, and the display of a virtual display object that is based on the selection posture when the virtual display object is selected.

In the present embodiment, a case in which a virtual display object that the user wishes to refer to is detected based on eye-gaze information will be exemplified.

<Description about Diagrams Illustrating Eye Gaze Detection>

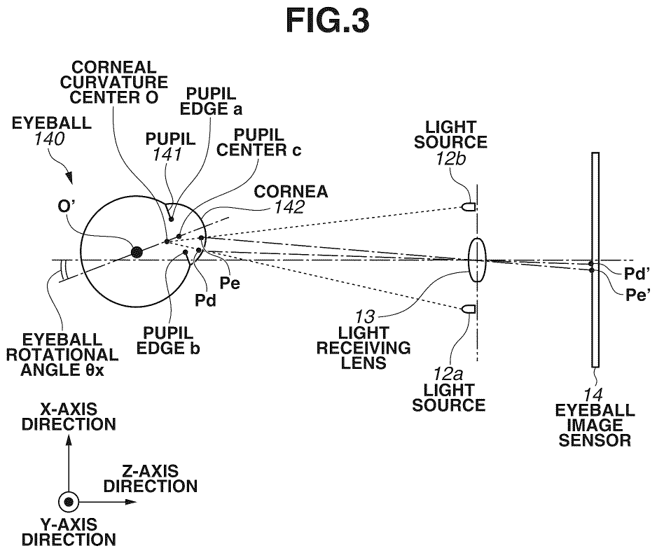

Hereinafter, eye gaze detection for acquiring eye-gaze information by the user will be described with reference to FIGS. 3 to 5. Although eye gaze detection of one eyeball will be described, the same applies to eye gaze detection of the other eyeball.

FIG. 3 is a schematic diagram illustrating the principle of an eye gaze detection method, and corresponds to an outline diagram of the optical system for performing the eye gaze detection described above with reference to FIG. 2. In FIG. 3, light sources 12a and 12b are light-emitting diodes or the like that emit infrared light imperceptible to the user. The light sources 12a and 12b are arranged substantially symmetrically with respect to an optical axis of the light receiving lens 13, and illuminate an eyeball 140 of the user. Part of illumination light reflected on the eyeball 140 is condensed by the light receiving lens 13 to the eyeball image sensor 14.

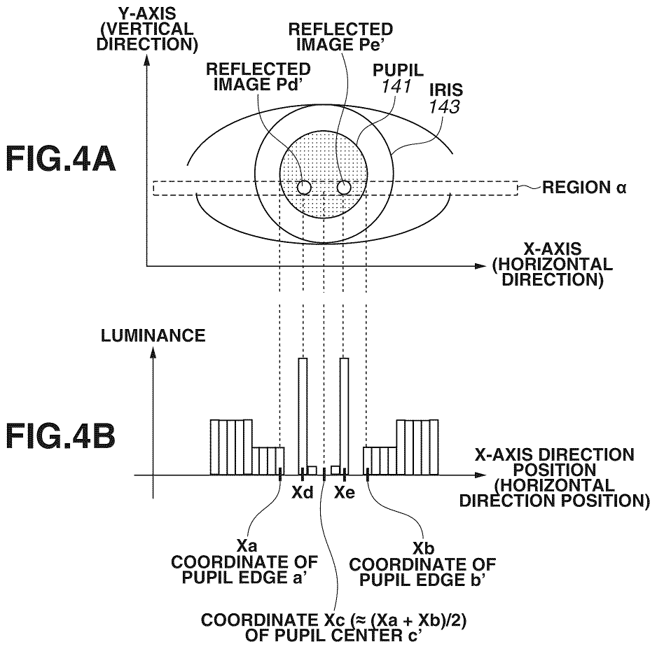

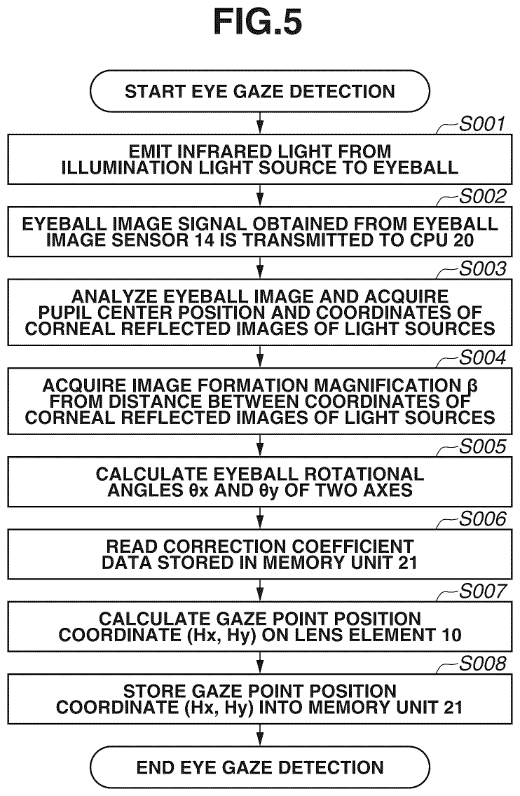

FIGS. 4A and 4B are schematic diagrams illustrating luminance at each position of an eyeball. FIG. 4A is a schematic diagram illustrating an eyeball image projected on the eyeball image sensor 14, and FIG. 4B is a diagram illustrating the output intensity of luminance on the eyeball image sensor 14. FIG. 5 is a flowchart illustrating an eye gaze detection operation according to the present embodiment.

### <Description of Eye Gaze Detection Operation>

In FIG. 5, when an eye gaze detection routine starts, in step S001, the light sources 12a and 12b emit infrared light toward the eyeball 140 of the user. An eyeball image of the user that has been illuminated with the above-described infrared light is formed on the eyeball image sensor 14 through the light receiving lens 13, photoelectrically converted by the eyeball image sensor 14, and the eyeball image becomes processable as an electric signal.

In step S002, the eye gaze detection unit 22 transmits, to the CPU 20, the eyeball image signal obtained from the eyeball image sensor 14 as described above.

In step S003, the CPU 20 obtains coordinates of points corresponding to a pupil center c and corneal reflected images Pd and Pe of the light sources 12a and 12b, which are illustrated in FIG. 3, from information regarding the eyeball image signal obtained in step S002. The infrared light emitted by the light sources 12a and 12b illuminates a cornea 142 of the eyeball 140 of the user. At this time, the corneal reflected images Pd and Pe formed by part of infrared light reflected on the surface of the cornea 142 are condensed by the light receiving lens 13, and formed on the eyeball image sensor 14 (points corresponding to reflected images Pd′ and Pe′ illustrated in FIG. 3). Similarly, light beams from edges a and b of a pupil 141 also form an image on the eyeball image sensor 14.

In FIG. 4A, the horizontal direction is defined as the X-axis and the vertical direction as the Y-axis. At this time, coordinates in the X-axis direction (the horizontal direction) of the reflected images Pd′ and Pe′ formed as corneal reflected images of the light sources 12a and 12b are defined as Xd and Xe. In addition, coordinates in the X-axis direction of images a′ and b′ formed by light beams from edges a and b of the pupil 141 are denoted by Xa and Xb.

In a luminance information example illustrated in FIG. 4B, at the position coordinates Xd and Xe corresponding to the reflected images Pd′ and Pe′ formed as the corneal reflected images of the light sources 12a and 12b, luminance at an extremely strong level is obtained. In a region from the coordinate Xa to the coordinate Xb, which corresponds to the region of the pupil 141, excluding the positions of the coordinates Xd and Xe, luminance at an extremely low level is obtained. In contrast to this, in a region with a value of an X coordinate lower than the coordinate Xa, and a region with a value of an X coordinate higher than the coordinate Xb, which correspond to a region of an iris 143 on the outside of the pupil 141, a value intermediate between the above-described two types of luminance levels is obtained. From luminance level variation information with respect to an X coordinate position, the X coordinates Xd and Xe of the reflected images Pd′ and Pe′ formed as the corneal reflected images of the light sources 12a and 12b, and the X coordinates Xa and Xb of the images a′ and b′ of the pupil edges are obtained. In addition, in a case where a rotational angle θx of an optical axis of the eyeball 140 with respect to an optical axis of the light receiving lens 13 is small, a coordinate Xc of a point (c′) corresponding to the pupil center c formed on the eyeball image sensor 14 can be represented as Xc≈(Xa+Xb)/2. From the foregoing, the X coordinate of the point c′ corresponding to the pupil center c formed on the eyeball image sensor 14, and the coordinates of the corneal reflected images Pd′ and Pe′ of the light sources 12a and 12b can be estimated.

In step S004, the CPU 20 calculates an image formation magnification β of an eyeball image. The image formation magnification β is a magnification to be determined based on the position of the eyeball 140 with respect to the light receiving lens 13, and can be substantially obtained as a function of an interval (Xd−Xe) of the corneal reflected images Pd′ and Pe′.

In step S005, the CPU 20 calculates eyeball rotational angles θx and Oy of two axes.

The X coordinate of the midpoint of the corneal reflected images Pd′ and Pe′ is substantially coincides with the X coordinate of the curvature center O of the cornea 142. Thus, if the standard distance between the curvature center O of the cornea 142 and the center c of the pupil 141 is denoted by Oc, the rotational angle θx on a Z-X plane of the optical axis of the eyeball 140 can be obtained from the following relational expression.

$$β \times Oc \times SIN θ x \approx \{ ( Xd + Xe ) / 2 \} - Xc$$

In addition, FIGS. 3 to 4B illustrate an example in which the rotational angle θx obtainable in a case where the eyeball of the user rotates in a plane vertical to the Y-axis is calculated, but a calculation method of the rotational angle θy in a case where the eyeball of the user rotates in a plane vertical to the X-axis is similar.

If the rotational angles θx and θy of the optical axis of the eyeball 140 of the user are calculated in step S005, then in step S006, the CPU 20 obtains the position of the eye gaze of the user (gaze point) on the lens element 10 using the rotational angles θx and θy. When a gaze point position is assumed to be a coordinate (Hx, Hy) corresponding to the center c of the pupil 141 on the lens element 10, the coordinate (Hx, Hy) can be calculated as follows.

$$Hx = m \times ( A x \times θ x + Bx )$$

$$Hy = m \times ( A y \times θ y + B y )$$

The coefficient m is a constant that is determined by the configuration of an optical system, is a conversion coefficient that converts the rotational angles θx and θy into a position coordinate corresponding to the center c of the pupil 141 on the lens element 10, and is predetermined and stored in the memory unit 21. In addition, Ax, Bx, Ay, and By are defined as eye gaze correction coefficients for correcting an individual difference in the eye gaze of the user, are obtained by performing a calibration operation, and are stored in the memory unit 21 before the eye gaze detection routine starts.

After the coordinate (Hx, Hy) of the center c of the pupil 141 on the lens element 10 is calculated as described above, in step S007, the CPU 20 stores the above-described coordinate into the memory unit 21.

As described above, the eye gaze detection routine ends.

In the above description, an acquisition method for a gaze point coordinate on the lens element that uses the corneal reflected images of the light sources 12a and 12b has been described, but the acquisition method is not limited to this. Any method can be applied in the present embodiment as long as the method is a method of acquiring an eyeball rotational angle from a captured eyeball image. In addition, a technique that does not use an eyeball image, such as a method of estimating eye gaze from the detection of an eye potential, can also be applied.

<Description of Position Control of Virtual Display Object that is Based on Working Posture>

In the present embodiment, the working posture of the user is pre-registered, and a virtual display object is displayed at a fixed display position set based on the registered information. The user wears the head-mounted display apparatus 1 and performs activation processing, and it is assumed that a necessary initial setting such as the calibration of eye gaze detection has been performed.

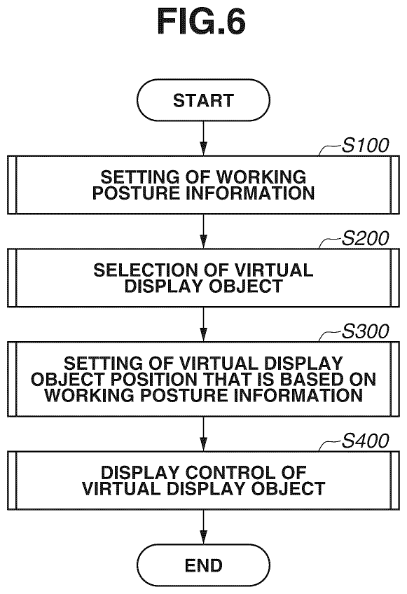

FIG. 6 is a flowchart illustrating the overview of a virtual display object position control method, which is based on the working posture of the user, according to the present embodiment.

In step S100, the setting of working posture information is executed. In step S200, the selection of a virtual display object is executed. In step S300, the position setting of the virtual display object based on working posture information is executed. In step S400, the display control of the virtual display object is executed. These steps are periodically invoked, in whole or in part, based on a set cycle and a trigger condition while the head-mounted display apparatus 1 is being used.

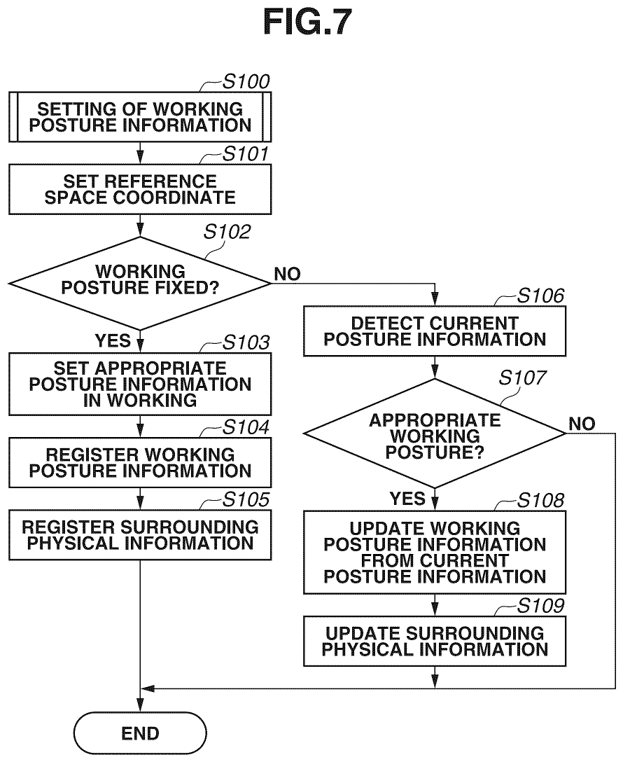

FIG. 7 is a flowchart illustrating a specific example of the setting of working posture information.

In the present embodiment, a case where the user wearing the head-mounted display apparatus 1 performs work in the real world using a work desk, a chair, a keyboard and a mouse that are placed on the work desk, and the like, while viewing a display, for example, serving as a virtual display object will be described. The user is seated on the chair facing the work desk, reaching for the keyboard and the mouse, and facing the direction in which the display is present. The spatial coordinate information of the face or various parts of the body (including the hand and the arm) at the working posture, orientation (direction) information of the face, the body, and the eye gaze, gesture information indicating the shape of the hand during working and the like correspond to the working posture information.

In step S101, the setting of a reference spatial coordinate is performed. This means causing the coordinate in the real world and the coordinate in the three-dimensional work system in the virtual space to match. The real world and digital elements are accordingly integrated, allowing the user to perceive a virtual object as if it exists in that space, place the virtual object within his/her viewing field, and experience an operational feeling as if manipulating the virtual object with his/her hand. The reference point is normally set when the virtual environment is activated, but may be reset at an arbitrary timing. Normally, a virtual object can move and rotate at six degrees of freedom corresponding to pitch, roll, yaw, left-right, forward-backward, and up-down directions. In addition, the movement of the user, and the directions of the face and the body, or the like can also be obtained as a change amount from the reference point based on a detection value of the gyro sensor or the acceleration sensor of the posture detection unit 25, for example.

In step S102, the CPU 20 determines whether the working posture is fixed. The user can preset whether the working posture is fixed. In the present embodiment, assuming that a fixed mode is selected (YES in step S102), hereinafter, the description will be given with reference to steps S103 to S105. The case of using steps S106 to S109 will be described in a second embodiment.

In step S103, appropriate posture information in working is set. The user assumes a working posture serving as a model working posture, and the position coordinates of the face and the body, the directions of the face and the body, and the like in the state are detected as a posture. In addition, the working posture information may include eye-gaze information (direction of eye gaze). The user can set a region of which body parts' information to use.

In addition, the state of the hand or the arm may be captured by the external world imaging unit 15, and may be used as gesture information. In addition, the optimum position coordinate of the display, which is a virtual display object at the working posture, may also be set as information.

In step S104, the working posture control unit 26 registers the working posture information. A plurality of pieces of working posture information may be registered.

In step S105, the external world imaging unit 15 detects surrounding physical information, such as the desk, the chair, the keyboard, and the like, the external information acquisition unit 23 acquires information regarding their positions and shapes, and the CPU 20 registers the information.

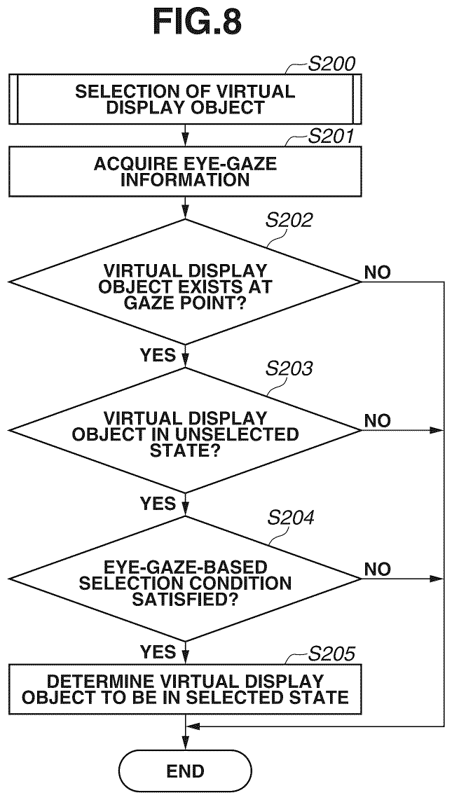

FIG. 8 is a flowchart illustrating a specific example of the selection of a virtual display object.

In the present embodiment, the selection of a virtual display object will be described using eye-gaze information of the user. The selection method is not limited to the method that uses eye-gaze information, and gesture information regarding the user such as pointing at the virtual display object, or directing a controller toward the virtual display object may be used. The gesture information is recognized by the gesture detection unit 24. Furthermore, for clarification of the selection, an input operation for confirmation, such as using a GUI, a controller button, a gesture, or the like, may be separately performed.

In step S201, the eye gaze detection unit 22 acquires eye-gaze information regarding the eye gaze of the user with respect to the virtual display object displayed by the virtual display object display unit 27, and the CPU 20 calculates an eye gaze position (gaze point).

In step S202, the CPU 20 determines whether a virtual display object exists at a gaze point.

In step S203, the virtual display object selection unit 28 determines the virtual display object in the gaze state is in a selected state or an unselected state. In a case where it is determined that the virtual display object is already in the selected state (NO in step S203), the virtual display object selection unit 28 maintains the detected virtual display object in the selected state, and the processing in FIG. 8 ends.

In step S204, the virtual display object selection unit 28 determines whether the eye-gaze-based selection conditions have been satisfied for the virtual display object determined to be in the unselected state in step S203.

Examples of the selection conditions include a condition that a gaze continues for a predetermined time without any interruption, a condition that a command button for selection determination that is provided within the frame of the virtual display object in the gaze state is input, a condition that a gesture assigned selection determination is executed in the gaze state, and the like.

In step S205, the virtual display object selection unit 28 determines the virtual display object that has satisfied the selection conditions to be in the selected state.

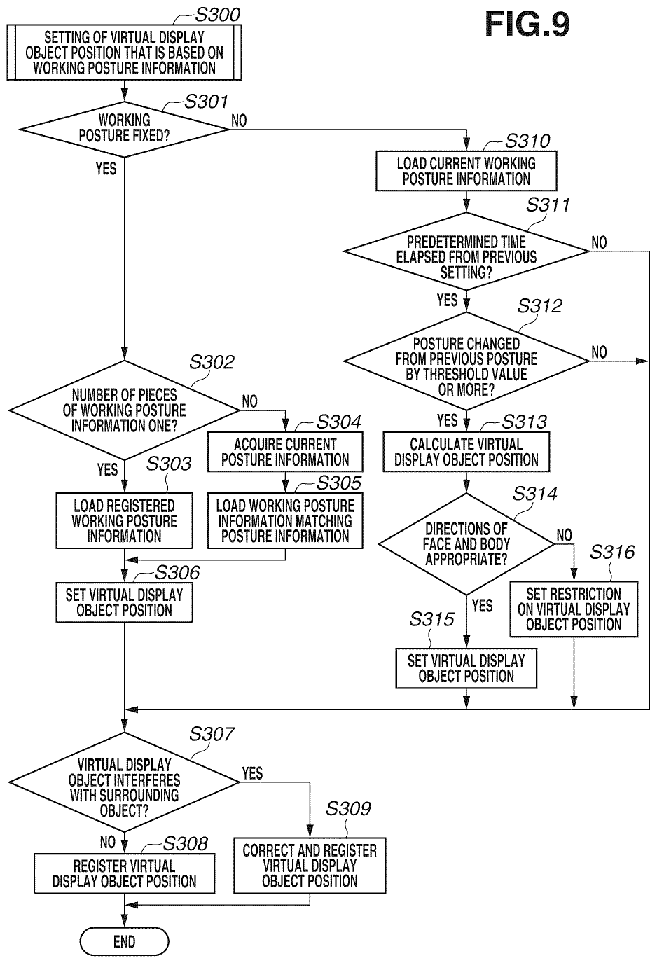

FIG. 9 is a flowchart illustrating a specific example of the position setting of a virtual display object that is based on working posture information.

In step S301, the CPU 20 determines whether the working posture is fixed. The user can preset whether the working posture is fixed. In the present embodiment, assuming that a fixed mode is selected (YES in step S301), the description will be given with reference to steps S302 to S309. The example of using steps S310 to S316 will be described in the second embodiment.

In step S302, the CPU 20 determines whether the number of pieces of working posture information is one or a plural number.

In step S302, in a case where it is determined that the number of pieces of working posture information is one (YES in step S302), the processing proceeds to step S303. In step S303, the CPU 20 loads the registered working posture information.

In step S302, in a case where it is determined that the number of pieces of working posture information is a plural number (NO in step S302), the processing proceeds to step S304. In step S304, the CPU 20 acquires the current working posture information. In step S305, the CPU 20 searches for working posture information matching the current working posture information, and loads the matching working posture information.

Since the working posture information includes the optimum position coordinate of the display, which is the virtual display object, in step S306, the virtual display object control unit 29 sets the display position of the virtual display object based on the loaded working posture information.

For example, the memory unit 21 stores physical information regarding a real object existing near the user. For this reason, in step S307, the CPU 20 acquires the above-described physical information from the memory unit 21, and determines whether the set position of the virtual display object interferes with the real object existing near the user. Examples of the interference include a case where the lower edge of the display, which is the virtual display object, is located below the upper surface of the real work desk. The examples also include a case where the display position of the virtual display object overlaps the display position of another virtual object.

In a case where it is determined in step S307 that the set position of the virtual display object does not interfere with the real object (NO in step S307), the processing proceeds to step S308. In step S308, the virtual display object control unit 29 performs the registration of the display position of the virtual display object.

In a case where it is determined in step S307 that the set position of the virtual display object interferes with the real object (YES in step S307), the processing proceeds to step S309. In step S309, the virtual display object control unit 29 performs the correction of the display position of the virtual display object. In the case of the above-described example of interference, the display position is adjusted in such a manner that the lower edge of the virtual display object is located above the upper surface of the work desk, and the virtual display object control unit 29 registers the adjusted position of the virtual display object.

Although not illustrated, in a case where another virtual display object already exists at the virtual display object position, the following measure is considered to be performed. Possible measures include, for example, returning the already-existing virtual display object to its previous position before moving it to the current display position, shifting the position by a space corresponding to the new virtual display object, or swapping the positions of both virtual display objects.

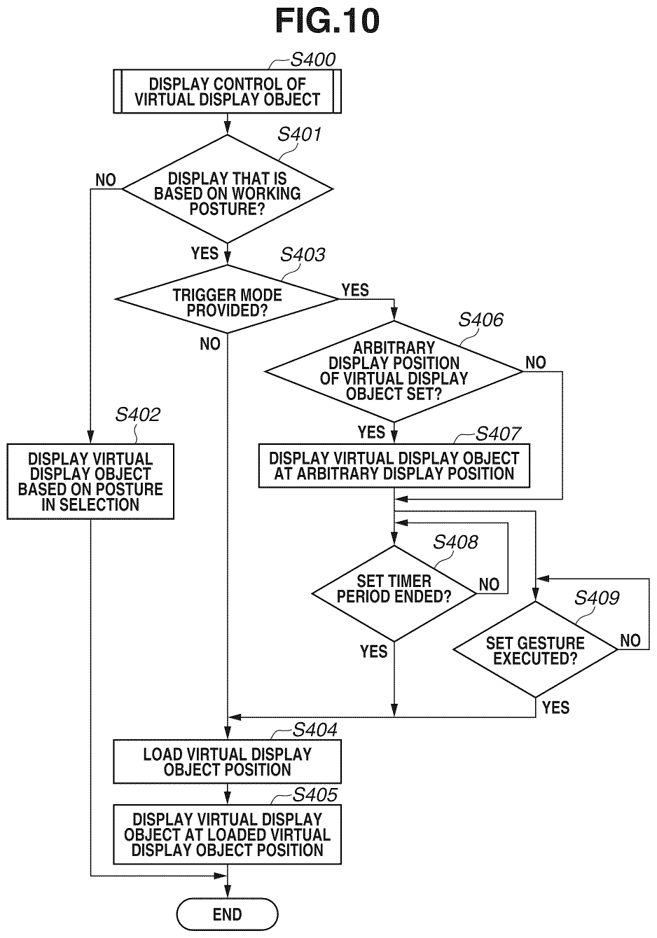

FIG. 10 is a flowchart illustrating a specific example of the display control of a virtual display object.

In step S401, the CPU 20 determines whether the display is the display of the virtual display object that is based on the working posture. The user can preset whether the display is the display of the virtual display object that is based on the working posture.

In a case where it is determined in step S401 that the display is the display that is based on the working posture (YES in step S401), the processing proceeds to step S403. On the other hand, in a case where it is determined that the display is the display that is not based on the working posture (NO in step S401), the processing proceeds to step S402. In step S402, the virtual display object display unit 27 performs processing for displaying the virtual display object in front of the eyes of the user. “Displaying the virtual display object in front of the eyes of the user” means the display that is based on the selection posture of the user when the virtual display object is selected.

In step S403, the virtual display object control unit 29 determines whether the display control of the virtual display object provides a trigger mode. The user can preset the presence or absence of the trigger mode. In the present embodiment, assuming that it is determined that the trigger mode is not provided (NO in step S403), hereinafter, the description will be given with reference to steps S403 to S405. The example of using steps S406 to S409 will be described in the second embodiment.

In step S404, the CPU 20 loads the display position of the virtual display object that has been set and registered.

In step S405, the virtual display object display unit 27 displays the virtual display object at the loaded display position. The selected virtual display object is accordingly displayed at a position appropriate for the user to refer to and work with, in such a manner that the virtual display object is located at a position in front of the user's eye in alignment with the working posture of the user, for example, when the user is seated and working.

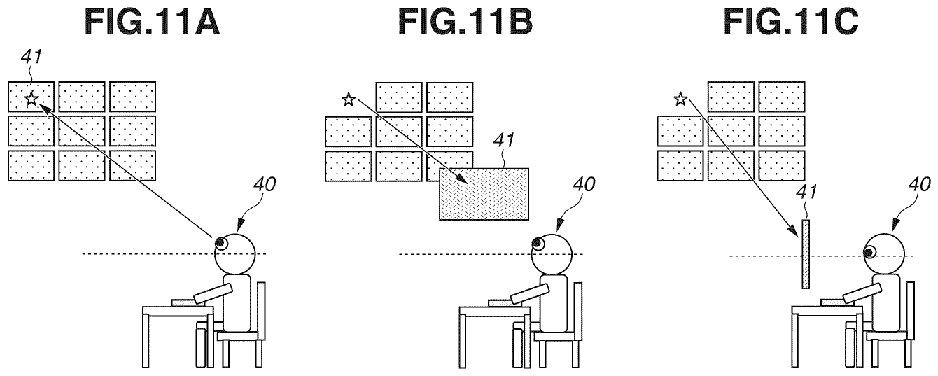

FIGS. 11A to 11C are schematic diagrams visually illustrating the display of a virtual display object according to the present embodiment. FIG. 11A illustrates a state in which the user selects a virtual display object. FIG. 11B illustrates, as a comparative example of the present embodiment, a state in which the selected virtual display object is displayed in front of the eyes. FIG. 11C illustrates a state in which the selected virtual display object is displayed based on a working posture according to the present embodiment.

In FIG. 11A, a user 40 of the head-mounted display apparatus 1 assumes a working posture, and selects a virtual display object 41 to be referred to (display at a position with a star mark), from among a plurality of virtual display objects located at positions away from the position of the working posture. Here, the selection is performed based on eye-gaze information, and the selection is determined based on the continuation of the gaze.

In FIG. 11B, the virtual display object 41 can be displayed in front of the user 40; however, the display position of the virtual display object 41 is not a position appropriate for working while referring to the virtual display object 41.

The user 40 additionally performs an operation of pulling the virtual display object 41 to a position appropriate for working, by a gesture or the like, which becomes inefficient for the user in situations where the user is unwilling to disturb his/her working posture such as a hand position.

In FIG. 11C, after the user 40 selects the virtual display object 41, the user 40 can perform work while referring to the virtual display object 41 that has moved to the position in front of the eyes in alignment with the working posture of the user 40, without going through the display state of the virtual display object 41 in FIG. 11B or disturbing his/her working posture.

This improves the convenience in the usage of the head-mounted display apparatus 1.

As described above, by considering the working posture of the user who refers to the virtual display object in the selection and movement of the virtual display object, it is possible to arrange the virtual display object at a position appropriate for the user, and therefore, the head-mounted display apparatus 1 with improved convenience and work efficiency is realized.

### Second Embodiment

Hereinafter, the second embodiment of the present disclosure will be described.

In the present embodiment, similarly to the first embodiment, a head-mounted display apparatus that arranges a virtual display object at a position appropriate for a user by considering a working posture of the user who refers to the virtual display object in the selection and movement of the virtual display object will be described as an image processing device. The present embodiment differs from the first embodiment in that processing of the flowcharts in FIGS. 7, 9, and 10 partially differs.

<Description about Position Control of Virtual Display Object that is Based on Real-Time Working Posture>

The basic overall flow according to the present embodiment is similar to that illustrated in FIG. 6. Each step is assumed to be invoked at an arbitrary cycle. Hereinafter, the present embodiment will be described with reference to FIGS. 7 to 10.

FIG. 7 is a flowchart illustrating a specific example of the setting of working posture information.

The present embodiment is similar to the first embodiment in that the user of the head-mounted display apparatus 1 works in the real world using a work desk, a chair, a keyboard and a mouse that are placed on the work desk, and the like, while viewing a display serving as a virtual display object. In the present embodiment, a case where the fixed mode is not selected, and a working posture is detected in real time will be described with reference to steps S106 to S109.

In step S106, the posture detection unit 25 detects the current working posture information. As the working posture information, the positions of the face and the body of the user, the directions of the face and the body, the gesture shapes of the hand and the arm, and the like are acquired. In addition, the working posture information may include eye-gaze information (direction of eye gaze). The user can appropriately set working posture information to be used.

In step S107, the CPU 20 determines whether the posture of the user is an appropriate working posture, based on the current working posture information detected in step S106. Whether the posture is the working posture is determined based on whether the hand of the user is handling a real object such as a keyboard or a mouse, for example. Although not illustrated in FIG. 7, a real object to be handled during work may be pre-registered. In addition, in a case where the orientation of the face extremely deviates from the orientation of the body in the left-right, or up-down direction, the posture is determined to be not an appropriate working posture. Similarly, in a case where the direction of eye gaze is used, in a case where the gaze is directed in an extreme direction relative to the orientation of the face, the posture is determined to be not an appropriate working posture.

To prevent situations where the working posture is never determined to be appropriate and working posture information is never registered before proceeding to subsequent processing, for example, only in a case where working posture information has never been registered, information that is based on the current working posture is registered. In this case, information regarding the orientations of the face and the eye gaze may desirably be corrected using information regarding the orientation of the body. Alternatively, a procedure of setting a special value indicating an error, as a default value, and stopping the processing in a case where the special value is read in in the subsequent processing may be employed. Furthermore, even if the posture is not determined to be appropriate once or several times, in a case where a similar posture is repeatedly detected and the number of detections exceeds a set threshold value, the posture may be recognized as a working posture.

In step S108, the working posture control unit 26 updates and sets the posture information detected in step S106, as working posture information, and registers the working posture information.

In step S109, the external information acquisition unit 23 acquires physical information surrounding the updated working posture, the CPU 20 updates, sets, and registers the physical information, and the setting of working posture information temporarily ends.

The selection processing of a virtual display object that is illustrated in FIG. 8 is similar to that in the first embodiment.

FIG. 9 is a flowchart illustrating a specific example of the position setting of a virtual display object that is based on working posture information.

In the present embodiment, assuming that the fixed mode is not selected and a working posture is detected in real time, the description will be given with reference to steps S310 to S316.

In step S310, the CPU 20 loads the updated and registered current working posture information.

In step S311, the CPU 20 determines whether a predetermined time has elapsed since the position of a virtual display object had been set the last time. In a case where the update of the virtual display object position is successively performed at a short cycle, and the position changes every time even slightly, the display, which is the virtual display object, will appear to keep shaking from the perspective of the user, and this leads to discomfort or a sense of motion sickness. Therefore, by broadening the update cycle of the virtual display object position, it is possible to avoid a situation where a display, which is the virtual display object, constantly shakes.

In step S312, the CPU 20 determines whether the current working posture has changed from the previous working posture information by an amount equal to or greater than a predetermined threshold value. This also serves to avoid continuous subtle updates of the virtual display object that could cause discomfort or a sense of motion sickness for the user. In a case where it is determined that only a slight change in virtual display object position is detected, i.e., the change in working posture is determined to be small (NO in step S312), the virtual display object continues to be displayed at the same position. In a case where it is determined that the working posture has greatly varied exceeding the threshold value (YES in step S312), the virtual display object control unit 29 updates and sets the display position of the virtual display object.

In step S313, the CPU 20 calculates the position of the virtual display object. Unlike in the fixing mode, the virtual display object is not displayed at a designated fixed coordinate, but is updated based on the working posture information. Since the virtual display object is basically arranged within the viewing field of the working posture, the CPU 20 may calculate the display position of the virtual display object based on position information and orientation (direction) information of the face of the user, for example.

In this case, based on the position of the face, a spatial coordinate in an arbitrary defined relative distance in the direction of the face may be specified. In addition, in a case where eye-gaze information is used, based on the position of the face, a spatial coordinate in an arbitrary defined relative distance in the direction of the eye gaze may be specified.

In step S314, the CPU 20 determines whether the calculated display position of the virtual display object is appropriate for the directions of the face and the body of the user and the orientation of the eye gaze. In a case where the display position of the virtual display object is calculated based on the position and the orientation (direction) of the face in step S313, it is determined whether the display position of the virtual display object (i.e., the direction of the face) is not in an extreme direction relative to the orientation (direction) of the body.

In a case where it is determined in step S314 that the display position of the virtual display object is appropriate (YES in step S314), the processing proceeds to step S315. In step S315, the virtual display object control unit 29 sets and registers the calculated position of the virtual display object as is.

In a case where it is determined in step S314 that the display position of the virtual display object is not appropriate (NO in step S314), the processing proceeds to S316. In step S316, the virtual display object control unit 29 sets a restriction on the calculated display position of the virtual display object. More specifically, the virtual display object control unit 29 sets a restriction on the direction of the position of the virtual display object based on the orientation (direction) of the body in such a manner that the orientation (direction) of the face falls within a threshold angle in the up-down and left-right directions, and the CPU 20 calculates the position coordinate of the virtual display object again. The restriction setting is similarly performed as for eye-gaze information.

However, even if the direction is extreme, as described above in step S107, in a case where the posture is recognized as a working posture, the restriction may not be set.

The processing in steps S307 to S309 thereafter is similar to that in the first embodiment.

FIG. 10 is a flowchart illustrating a specific example of the display control of a virtual display object.

In the present embodiment, in the display control of a virtual display object, a case where a trigger mode for displaying the selected virtual display object at the display position of the virtual display object is provided will be described with reference to steps S406 to S409.

In step S406, the CPU 20 determines whether there is an arbitrary setting for the display position of a virtual display object. The determination is performed to determine whether, before the virtual display object is displayed at the display position calculated for the virtual display object, the virtual display object is set to be displayed at a different display position other than the calculated display position, and the user sets the presence or absence of the display and the display position.

In a case where it is determined in step S406 that the virtual display object is set to be displayed at an arbitrary display position (YES in step S406), the processing proceeds to step S407. In step S407, the virtual display object display unit 27 displays the virtual display object at the arbitrary display position.

In a case where it is determined in step S406 that the virtual display object is not set to be displayed at an arbitrary display position (NO in step S406), the processing proceeds to steps S408 and S409 described below, without proceeding to step S407.

In step S408, the CPU 20 determines whether a timer period set by the virtual display object control unit 29 as a trigger condition has ended. The timer is started based on, for example, the selection and determination of the virtual display object. If an arbitrarily set timer period ends, the trigger is activated, and the virtual display object is automatically displayed at the calculated display position.

In step S409, the CPU 20 determines whether a gesture set by the virtual display object control unit 29 as a trigger condition has been executed by the user. The gesture may be arbitrarily set for triggering, for example. If the trigger is activated by the execution of the gesture, the virtual display object is automatically displayed at the calculated display position. For example, by setting, as a trigger gesture, the shape or the movement of the hand during work that has been registered as working posture information, the virtual display object display unit 27 can display the virtual display object at a display position corresponding to the working posture simultaneously when the user assumes the working posture.

The processing in steps S404 to S405 is similar to that in the first embodiment.

For example, a case where steps S407 and S409 are combined will be described below.

If the user selects a virtual display object in a standing state, for example, the virtual display object is temporarily displayed in front of the eyes of the user in the standing posture. If the user sits down and assumes a working posture after confirming the content of the virtual display object, the virtual display object is automatically displayed at a display position corresponding to the working posture. The processing that combines steps S407 and S409 can be effectively utilized especially in a case where the user selects a virtual display object at a position distant from the work position, such as a case where the virtual display object is hidden and invisible from the work position.

In the present embodiment, by detecting the working posture of the user in real time, and calculating the display position of the virtual display object based on the working posture information, the user can continue to work while referring to the virtual display object even if the user is at an arbitrary work position and assumes an arbitrary working posture. In addition, in the present embodiment, by incorporating the trigger mode into the display control of the virtual display object, it becomes possible to confirm the content of the virtual display object in advance, making it easier to handle the virtual display object distant from the work position. As described above, the head-mounted display apparatus according to the present embodiment can improve the degree of freedom and convenience for the user's work.

### Third Embodiment

Hereinafter, the third embodiment of the present disclosure will be described.

In the present embodiment, similarly to the first embodiment, a head-mounted display apparatus that arranges a virtual display object at a position appropriate for a user by considering a working posture of the user who refers to the virtual display object in the selection and movement of the virtual display object will be described as an image processing device. The present embodiment differs from the first embodiment in that the number of virtual display objects to be selected is not one but a plural number, and a plurality of virtual display objects is all associated in such a manner as to be simultaneously referred to during working.

In a case where the user of the head-mounted display apparatus 1 works while referring to a virtual display object, there may be cases where information supplementing the content of the virtual display object is described in another virtual display object. In the present embodiment, a relationship between such virtual display objects will be expressed as “being associated” and “having a high relevance degree”. There may be situations where the user desires to collectively display a set of a plurality of virtual display objects with a high relevance degree, at the work position.

<Description of Selection and Position Control of Plurality of Virtual Display Objects with High RelevanceDegree>

The basic processing according to the present embodiment is similar to that in the first embodiment illustrated in FIGS. 6 to 10; however, the main differences lie in selecting a plurality of virtual display objects with a high relevance degree in the selection of virtual display objects, and controlling a plurality of virtual display objects with a high relevance degree to be displayed in the display control of virtual display objects.

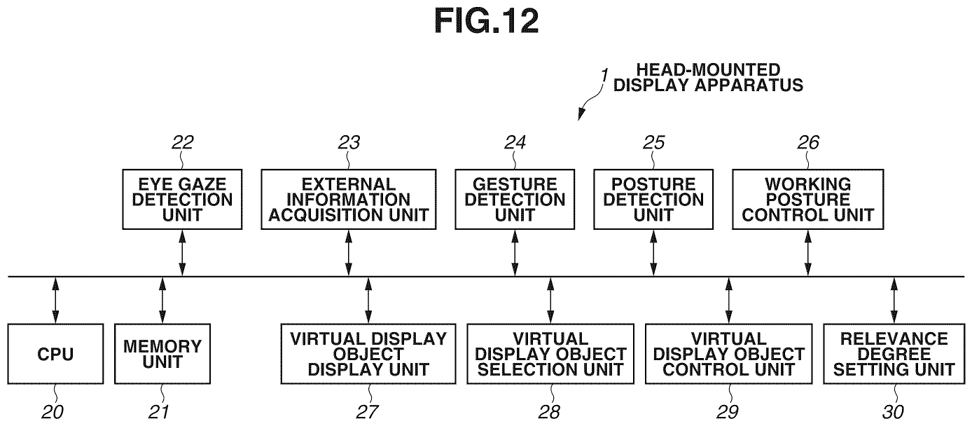

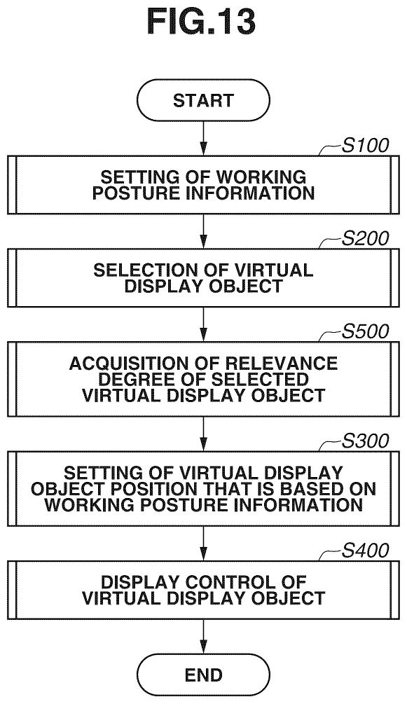

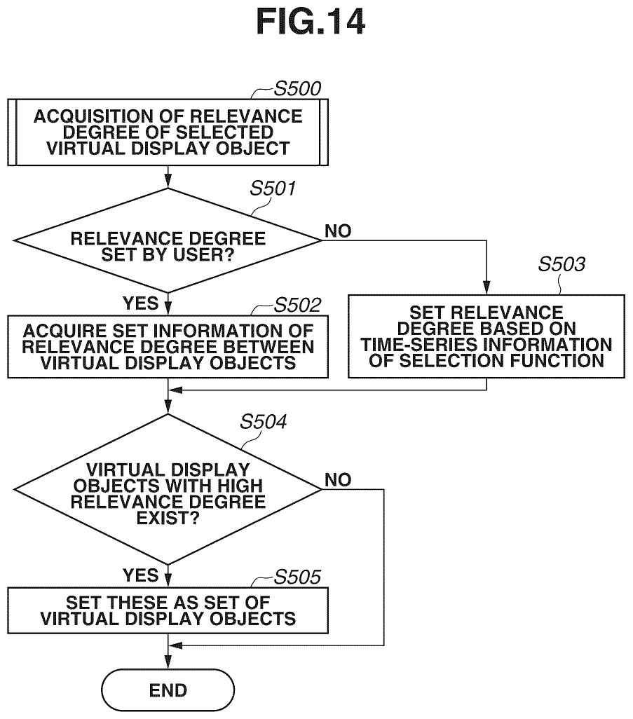

FIG. 12 is a block diagram illustrating an electrical configuration of the head-mounted display apparatus 1 according to the present embodiment. FIG. 13 is a flowchart illustrating the overview of a virtual display object position control method according to the present embodiment, which is based on the working posture of the user. FIG. 14 is a flowchart illustrating a specific example of the acquisition of the relevance degree of selected virtual display objects.

As illustrated in FIG. 12, the head-mounted display apparatus 1 according to the present embodiment includes a relevance degree setting unit 30 in addition to the components 22 to 29 described in the first embodiment with reference to FIG. 2. The relevance degree setting unit 30 sets a relevance degree among a plurality of virtual display objects.

As illustrated in FIG. 13, in the present embodiment, between step S200 in which the selection of a virtual display object is performed and step S300 in which the position setting of the virtual display object based on working posture information is performed, step S500 in which a relevance degree among a plurality of selected virtual display objects is acquired is added.

As illustrated in FIG. 14, in step S501, the CPU 20 determines whether the user has already set a relevance degree between the selected virtual display object and another virtual display object.

In a case where it is determined in step S501 that the relevance degree has already been set (YES in in step S501), the processing proceeds to step S502. In step S502, the relevance degree setting unit 30 acquires already-set information regarding the relevance degree between virtual display objects. For example, when a virtual display object is activated, the user may set a relevance degree with respect to an already-activated different virtual display object. In addition, the user may set a relevance degree by creating a sibling relationship through duplication of a virtual display object. In a case where a virtual display object with a high relevance degree with respect to the selected virtual display object as described above exists, that information is provided to the relevance degree setting unit 30.

In a case where it is determined in step S501 that a relevance degree has not been set yet (NO in step S501), the processing proceeds to step S503. In step S503, the relevance degree setting unit 30 performs automatic setting of a relevance degree based on time-series information of the selection function. Information to be used for selection includes eye-gaze information, a gesture, a controller, and the like. Here, eye-gaze information is to be used.

For example, a past gaze history of a virtual display object may be used. Virtual display objects with a high relevance degree are cross-referred to by the user at a high frequency. Therefore, the relevance degree between virtual display objects may be automatically set based on such information. In addition, a method of selecting a main virtual display object, then shifting the eye gaze to a sub virtual display object to place both of them in a selected state simultaneously may be employed. Selection of a plurality of virtual display objects by eye gaze may be performed by combining specific gestures, or embedding a specific pattern in the eye gaze trajectory. In a case where the condition for a relevance degree is not satisfied, the setting of a relevance degree is not performed.

In step S504, the CPU 20 determines whether another virtual display object that has a high relevance degree with respect to the selected virtual display object exists.

In a case where it is determined in step S504 that a virtual display object with a high relevance degree exists (YES in in step S504), the processing proceeds to step S505. In step S505, the relevance degree setting unit 30 sets both virtual display objects as a set of virtual display objects. As a relationship between the virtual display objects, the directly-selected virtual display object is a main virtual display object, and the virtual display object with a high relevance degree is a sub virtual display object. A plurality of virtual display objects with a high relevance degree may exist. In addition, a priority order may be further set to the virtual display objects with a high relevance degree.

Subsequently, in step S300, the virtual display object control unit 29 sets and registers the display positions of the virtual display objects collectively as a set based on the working posture. In step S400, the virtual display object display unit 27 collectively displays the set of virtual display objects at the set display positions.

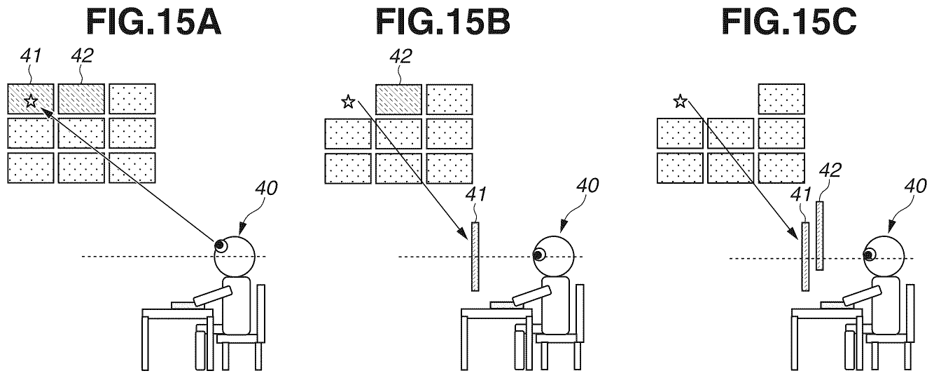

FIGS. 15A to 15C are schematic diagrams visually illustrating the display of a plurality of virtual display objects with a high relevance degree according to the present embodiment.

FIG. 15A illustrates a state in which the user 40 selects a virtual display object. The user 40 assumes a working posture, and selects a virtual display object 41 to be referred to (display at a position with a star mark), from among a plurality of virtual display objects at positions located away from the working posture of the user 40. The selection is performed based on eye-gaze information, and the selection is determined based on the continuation of the gaze. A virtual display object 42 located on the right of the selected virtual display object 41 is set as a virtual display object with a high relevance degree with respect to the selected virtual display object 41. As a relationship between virtual display objects, the directly-selected virtual display object 41 is a main virtual display object, and the virtual display object 42 with a high relevance degree that is located on the right of the selected virtual display object 41 is a sub virtual display object.

Similarly to the first and second embodiments, FIG. 15B illustrates a state in which only the selected virtual display object 41 is displayed based on the working posture of the user 40. The user 40 can work while referring to the main virtual display object 41; however, the user 40 needs to appropriately refer to the sub virtual display object 42 in order to refer to supplementary information of the content of the virtual display object 41. In a state in which the virtual display objects are separated, it is difficult to refer to them, and displaying the sub virtual display object 42 again at the work position requires extra effort.

FIG. 15C illustrates a state in which a set of the selected virtual display object 41 and the virtual display object 42 with a high relevance degree with respect to the virtual display object 41 are collectively displayed based on the working posture of the user 40 in the present embodiment. Since the virtual display objects 41 and 42 to be cross-referred to are collectively displayed, there is no need to display the sub virtual display object 42 again at the work position, providing excellent convenience.

In a case where a set of virtual display objects with a high relevance degree are collectively displayed at a working posture position, a selected virtual display object serving as a main virtual display object may be displayed at a position with a higher visibility where the user can easily refer to. For example, in a case where face or eye-gaze information is used as working posture information, it is considered that the main virtual display object is placed in the direction of the eye gaze, and the sub virtual display object is arranged at an arbitrary position near the main virtual display object.

A head-mounted display apparatus for MR, AR, and particularly VR is equipped with a technique called foveated rendering. This is a method of rendering the central visual field, which the user gazes at, in higher resolution, while rendering areas farther from the center in lower resolution, thereby enhancing the user's sense of immersion. The main virtual display object may be placed in the central visual field, and the sub virtual display object may be placed in the peripheral visual field. In a case where a plurality of sub virtual display objects is provided, a virtual display object with a higher priority order may be arranged at a position closer to the central visual field.

Further, the following arrangements may be applied to the display size of the virtual display object.

It is known that the extent of the central visual field of a human changes according to the degree of concentration during gaze, and this technique can also be applied to the foveated rendering. More specifically, in a case where it is determined that the user has a high degree of concentration and is gazing at the virtual display object serving as a main virtual display object, the size of the virtual display object may be increased in accordance with the extent of the central visual field (foveated rendering width). In contrast to this, in a case where it is determined that the user has a low degree of concentration and is in a state of viewing the entirety, the size of the set of main and sub virtual display objects may be reduced, and the virtual display objects may be arranged in such a manner that the user can recognize the entirety. The degree of concentration of the user can be acquired from time-series eye-gaze information, for example, and it can be determined that the user has a higher degree of concentration when the fluctuation of the eye gaze is smaller.

In the present embodiment, by collectively displaying virtual display objects with a high relevance degree at a working posture position as a set, it becomes unnecessary to perform a display operation of the virtual display objects a plurality of times. In addition, since a set of virtual display objects with a high relevance degree are located near the user, it becomes easier to cross-refer to the virtual display objects. As described above, the head-mounted display apparatus 1 according to the present embodiment can improve the degree of users' freedom and convenience for user's work.

Heretofore, various embodiments of the present disclosure have been described; however, the present disclosure is not limited to these embodiments, and various modifications and changes can be made without the scope of its gist.

In the above-described various embodiments, a storage medium such as the memory unit 21 stores a computer program for controlling the head-mounted display apparatus 1. The computer program is a program for implementing the various functions of the CPU 20 and the components 22 to 30 of the head-mounted display apparatus 1. Specifically, the computer program is a program corresponding to the steps illustrated in FIGS. 5, 7, 8, 9, 10, 14, and the like. In FIG. 5, the computer program corresponds to steps S001 to S008, in FIG. 7, the computer program corresponds to steps S101 to S109, in FIG. 8, the computer program corresponds to steps S201 to S205, in FIG. 9, the computer program corresponds to steps S301 to S316, in FIG. 10, the computer program corresponds to steps S401 to S409, and in FIG. 14, the computer program corresponds to steps S501 to S505. Then, the CPU 20, functioning as a computer, reads out the computer program from the storage medium such as the memory unit 21, and executes the computer program.

According to an embodiment of the present disclosure, it is possible to realize an image processing device with excellent convenience that can arrange a virtual display object at a position appropriate for a user by considering the working posture of the user who performs work while referring to the virtual display object in the selection and movement of the virtual display object.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016814, filed Feb. 4, 2025, which is hereby incorporated by reference herein in its entirety.

What is claimed is:

1. An image processing device comprising:
one or more memories; and
one or more processors in communication with the one or more memories, wherein the one or more processors and the one or more memories are configured to:
recognize a virtual display object selected in a virtual space;
set working posture information corresponding to a working posture of a user when the user works while referring to the virtual display object; and
set a display position of the virtual display object based on the set working posture information.

2. The image processing device according to claim 1, wherein the one or more processors and the one or more memories are further configured to display the virtual display object at the display position.

3. The image processing device according to claim 2, wherein, as a trigger condition for displaying the virtual display object at the display position, a timer period or execution of a gesture of the user is set.

4. The image processing device according to claim 1,
wherein the one or more processors and the one or more memories are further configured to
detect eye gaze of the user, and
recognize the selected virtual display object using information regarding the detected eye gaze.

5. The image processing device according to claim 4, wherein the selected virtual display object is recognized based on a time-series gaze state of the eye gaze of the user with respect to the virtual display object.

6. The image processing device according to claim 1, wherein, in a case where the working posture is fixed, the display position of the virtual display object is set to an absolute spatial coordinate position specified for a position of the working posture.

7. The image processing device according to claim 1, wherein, in a case where the working posture varies, the display position of the virtual display object is set to a relative spatial coordinate position that is based on the working posture.

8. The image processing device according to claim 7, wherein, in a case where the working posture varies, when it is determined that a posture in updated current working posture information has changed from a posture in previous working posture information by an amount equal to or greater than a predetermined threshold value, the display position of the virtual display object is updated.

9. The image processing device according to claim 1,
wherein the one or more processors and the one or more memories are further configured to
detect a posture of the user, and
calculate amounts of change in at least a position of a face of the user and an orientation of the face based on the detected posture.

10. The image processing device according to claim 9, further comprising:
at least one of a gyro sensor and an acceleration sensor.

11. The image processing device according to claim 1, wherein the working posture information is at least one of spatial coordinate information, orientation information, and gesture information of a face, a body, and an eye gaze of the user at the working posture.

12. The image processing device according to claim 1,
wherein the one or more processors and the one or more memories are further configured to
acquire a position of a real object existing near the user, and
adjust the display position of the virtual display object in such a manner as not to interfere with the acquired position of the real object.

13. The image processing device according to claim 1,
wherein the one or more processors and the one or more memories are further configured to
set the selected virtual display object and another virtual display object with a high relevance degree with respect to the selected virtual display object as a set, and
collectively set a display position of a plurality of virtual display objects set as the set, based on the working posture information.

14. An image processing method comprising:
recognizing a virtual display object selected in a virtual space;
setting working posture information corresponding to a working posture of a user when the user works while referring to the virtual display object; and
setting a display position of the virtual display object based on the set working posture information.
